(19) United States
(12) Patent Application Publication
(10) Pub. No.: US 2019/0303999 A1
(43) Pub. Date: Oct. 3, 2019

(54) VEHICLE SEARCH SYSTEM, VEHICLE SEARCH METHOD, AND VEHICLE SEARCH PROGRAM

(71) Applicant: Toyota Jidosha Kabushiki Kaisha, Toyota-shi Aichi-ken (JP)

(72) Inventors: Takashige Hori, Aisai-shi Aichi-ken (JP); Katsunori Takami, Tachikawa-shi Tokyo (JP)

(73) Assignee: Toyota Jidosha Kabushiki Kaisha, Toyota-shi Aichi-ken (JP)

(21) Appl. No.: 16/363,493

(22) Filed: Mar. 25, 2019

(30) Foreign Application Priority Data
Mar. 27, 2018 (JP) 2018-060384

(51) Int. Cl. G06Q 30/06; G06Q 10/02; G06Q 50/30; B60W 40/09

(52) U.S. Cl. CPC G06Q 30/0631; B60W 40/09; G06Q 50/30; G06Q 10/02

(57) ABSTRACT

A vehicle search system capable of searching a vehicle having an operating feel which matches, as much as possible, a driving tendency of a user. The vehicle search system includes: a storage unit which stores driving characteristic information indicating a driving tendency of a user; a storage unit which stores operating feel characteristic information indicating an operating feel of each of a plurality of vehicles; and a searching unit which compares the driving characteristic information and the operating feel characteristic information with each other and searches, among the plurality of vehicles, one or more vehicles having a degree of matching with the driving tendency of the user that exceeds a threshold.

### CROSS-REFERENCE TO RELATED APPLICATIONS

This application claims priority to Japanese Patent Application No. 2018-060384 filed on Mar. 27, 2018, which is incorporated herein by reference in its entirety including the specification, drawings, and abstract.

### BACKGROUND

### Field

The present disclosure relates to a vehicle search system, a vehicle search method, and a vehicle search program.

### Description of Related Art

Against a backdrop of advances in information and communication technology and changing lifestyles or for economic reasons, we are in the midst of a transition from an era of individual ownership to an era of sharing in the community. With car sharing, users who are members can share vehicles and check availability of the vehicles or make a reservation for use of the vehicles via the Internet or the like. As a system for searching a vehicle desired by a user, for example, a mediation system described in Patent Publication JP-A-2008-52663 is known. In the mediation system, a lender of a vehicle specifies use evaluation criteria and performs a good user search while a renter of a vehicle specifies use evaluation criteria and performs a good privately owned car search. Previous evaluation results of lenders and renters are registered in a member usage status management database. A privately owned car search examination setting server mediates between a lender and a renter who satisfy use evaluation criteria.

### SUMMARY

User preferences related to an operating feel of a vehicle may differ from user to user. For example, a user may prefer that a strong force be required to operate an operating member (for example, a steering wheel, an accelerator pedal, or a brake pedal) of a vehicle, but another user may prefer that a weak force be required to operate the operating member of a vehicle. In addition, for example, a user may prefer kilometer per hour as a display format of a speedometer but another user may prefer mile per hour as the display format of the speedometer. Meanwhile, a driving tendency which a lender of a vehicle desires with respect to a user to be a renter of the vehicle may differ from lender to lender. For example, a lender may desire that the user use the vehicle cleanly but another lender may desire that a user drive the vehicle safely.

However, with the mediation system described in Patent Publication JP-A-2008-52663, neither a vehicle having an operating feel matching a driving tendency of a user nor a vehicle for a user having a driving tendency matching those desired by a lender can be searched.

In consideration thereof, an object of the present disclosure is to propose a vehicle search system capable of searching a vehicle having an operating feel which matches, as much as possible, a driving tendency of a user. Another object of the present disclosure is to propose a vehicle search system capable of searching a vehicle for a user having a driving tendency which matches, as much as possible, a driving tendency desired by a lender.

In order to solve the problems described above, a vehicle search system according to the present disclosure includes: a first storage unit which stores driving characteristic information indicating a driving tendency of a user; a second storage unit which stores operating feel characteristic information indicating an operating feel of each of a plurality of vehicles; and a searching unit which compares the driving characteristic information and the operating feel characteristic information with each other and searches, among the plurality of vehicles, one or more vehicles having a degree of matching with the driving tendency of the user that exceeds a threshold. Accordingly, a vehicle having an operating feel which matches, as much as possible, a driving tendency of a user can be searched.

The vehicle search system according to the present disclosure may further include a third storage unit which stores, in association with a vehicle, desire information indicating a driving tendency which a lender of the vehicle desires with respect to a user to be a renter of the vehicle. The searching unit may further compare the driving characteristic information and the desire information with each other and search, among the plurality of vehicles, one or more vehicles having a sum of a degree of matching with the driving tendency of the user and a degree of matching with a desire of the lender that exceeds a threshold. Accordingly, a vehicle can be searched for a user having a driving tendency which matches, as much as possible, a driving tendency desired by a lender.

With the vehicle search system according to the present disclosure, a vehicle having an operating feel which matches, as much as possible, a driving tendency of a user can be searched. In addition, according to the vehicle search system according to the present disclosure, a vehicle can be searched for a user having a driving tendency which matches, as much as possible, a driving tendency desired by a lender.

### BRIEF DESCRIPTION OF DRAWINGS

FIG. 1 is an explanatory diagram showing a hardware configuration of a vehicle search system according to an embodiment of the present disclosure;

FIG. 2 is an explanatory diagram showing functional blocks of the vehicle search system according to the embodiment of the present disclosure; and

FIG. 3 is a flow chart showing a flow of processes by a vehicle search method according to the embodiment of the present disclosure.

### DETAILED DESCRIPTION

Hereinafter, an embodiment of the present disclosure will be described with reference to the drawings. In the drawings, a same reference numeral denotes a same component and redundant descriptions will be omitted.

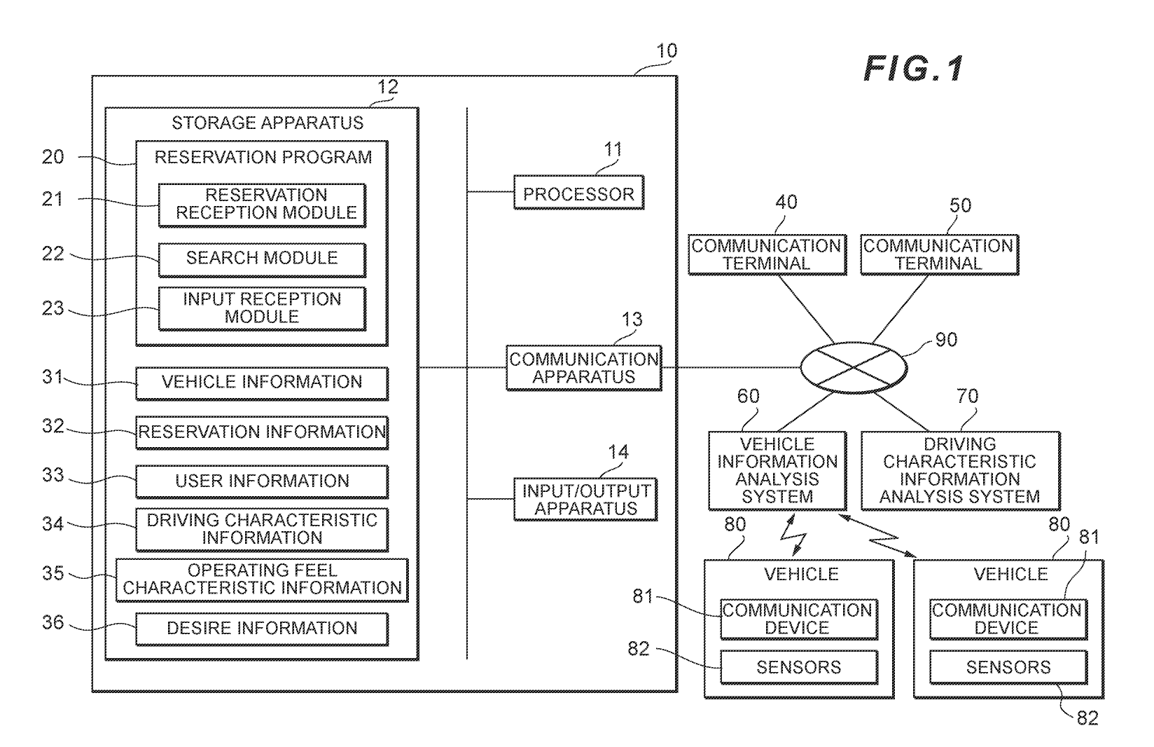

FIG. 1 is an explanatory diagram showing a hardware configuration of a vehicle search system 10 according to an embodiment of the present disclosure. The vehicle search system 10 is a computer system (for example, a web server) which performs processes related to reservation reception and search of a vehicle 80. The vehicle 80 is, for example, a shared car. A “shared car” refers to a rent-by-the-hour vehicle that is provided for use in sharing (for example, shared use among members who are users). A “vehicle” includes vehicles (for example, an automobile, a motorized bicycle, and a light vehicle) as defined in the Road Traffic Act. Each vehicle 80 may include, for example, a communication device 81 having a wireless communication function and sensors 82 which detect a driving state of the vehicle 80.

The vehicle search system 10 includes, as hardware resources thereof, a processor 11, a storage apparatus 12, a communication apparatus 13, and an input/output apparatus 14. The storage apparatus 12 stores a reservation program 20 which performs processes related to reservation reception and search of the vehicle 80 as well as various types of information (for example, vehicle information 31, reservation information 32, user information 33, driving characteristic information 34, operating feel characteristic information 35, and desire information 36) used in the processes related to the reservation reception and search. Details of the various types of information will be provided later. The reservation program 20 includes a reservation reception module 21, a search module 22, and an input reception module 23. These modules are subprograms modularized by function and are created using, for example, a procedure, a subroutine, a method, a function, and a data structure. Details of functions of the reservation reception module 21, the search module 22, and the input reception module 23 will be provided later. Note that the search module 22 can also be referred to as a vehicle search program.

The storage apparatus 12 is a storage resource provided by a computer-readable storage medium (for example, a volatile memory, a non-volatile semiconductor memory, an optical disk medium, or a magnetic disk medium). The communication apparatus 13 is a communication device supporting a communication standard such as Long Term Evolution. The input/output apparatus 14 includes an input device (for example, a keyboard, a mouse, or a touch panel) for inputting information to the vehicle search system 10 and an output device (for example, a display or a printer) for outputting information from the vehicle search system 10.

A user 41 is a member of car sharing, and a communication terminal 40 owned by the user 41 is mounted with an application program (for example, a web client) which performs various processes such as inputting, changing, and canceling a reservation for the vehicle 80. An owner 51 is a lender of the vehicle 80, and a communication terminal 50 owned by the owner 51 is mounted with an application program (for example, a web client) which performs a process of inputting the desire information 36. Note that the communication terminals 40 and 50 may be, for example, a mobile communication terminal equipped with a mobile communication function such as a multi-function mobile phone known as a smartphone or a tablet terminal, or a personal computer equipped with a communication function.

The vehicle search system 10, the communication terminal 40 and 50, a vehicle information analysis system 60, and a driving characteristic information analysis system 70 are connected via a communication network 90. The communication network 90 is, for example, a communication network in which a wired network (for example, a local area network (LAN), a wide area network (WAN), or a value-added network (VAN)) and a wireless network (a mobile communication network, a satellite communication network, Bluetooth (registered trademark), wireless fidelity (WiFi), high speed downlink packet access (HSDPA), or the like) coexist. Details of the vehicle information analysis system 60 and the driving characteristic information analysis system 70 will be provided later.

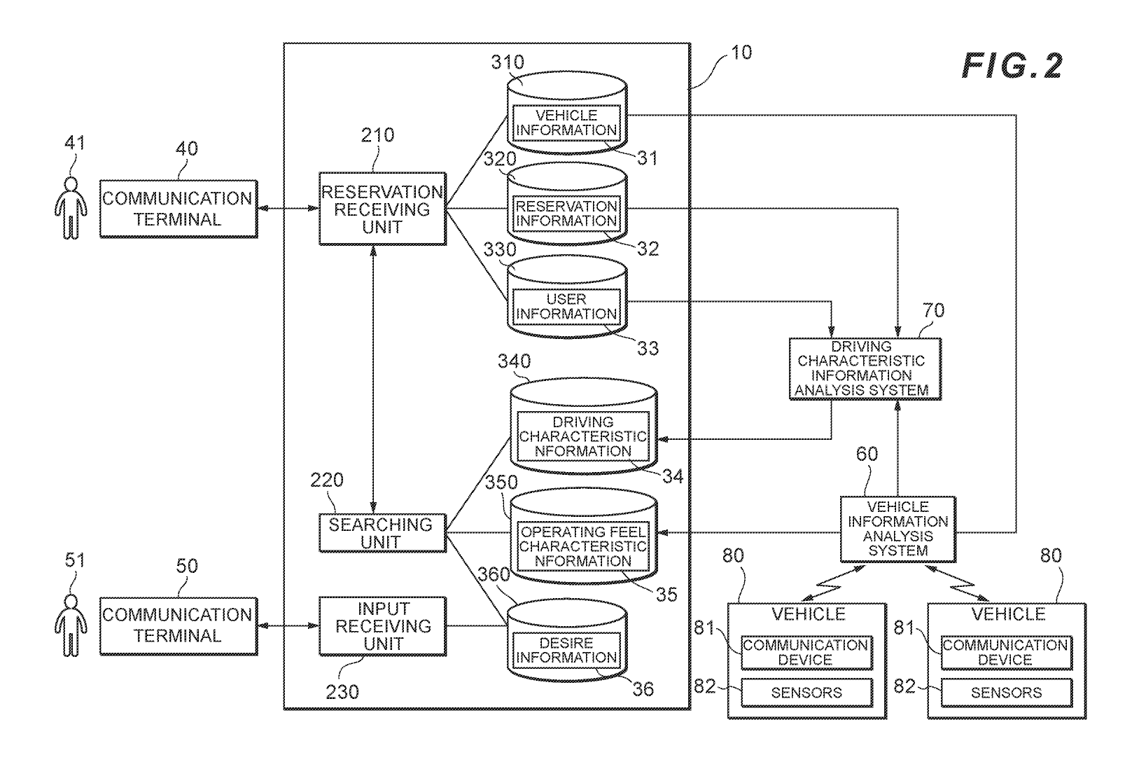

Next, functions of the vehicle search system 10 will be described mainly with reference to FIG. 2 and also with reference to FIG. 1 when appropriate.

The reservation reception module 21 performs processes related to receiving, changing, and canceling reservations for the vehicle 80. A function as a reservation receiving unit 210 is realized due to the reservation reception module 21 being interpreted and executed by the processor 11 and a hardware resource of the vehicle search system 10 and the reservation reception module 21 cooperating with each other.

The search module 22 performs a process of searching one or more vehicles from a plurality of vehicles 80. A function as a searching unit 220 is realized due to the search module 22 being interpreted and executed by the processor 11 and a hardware resource of the vehicle search system 10 and the search module 22 cooperating with each other.

The input reception module 23 performs a process of receiving input of the desire information 36 from the owner 51 who is the lender of the vehicle 80. A function as an input receiving unit 230 is realized due to the input reception module 23 being interpreted and executed by the processor 11 and a hardware resource of the vehicle search system 10 and the input reception module 23 cooperating with each other. Details of the desire information 36 will be provided later.

Each of storage units 310 to 360 is, for example, a logical volume provided by a storage area of the storage apparatus 12.

The storage unit 310 stores the vehicle information 31. The vehicle information 31 associates a vehicle ID which uniquely identifies the vehicle 80 with information related to specifications of the vehicle 80. Information related to specifications of the vehicle 80 include information indicating, for example, a vehicle name, a transmission type (for example, one of manual transmission, automatic transmission, continuously variable transmission, and dual clutch transmission, and an arrangement pattern of a shift lever), dimensions (for example, an overall length, an overall width, an overall height, a wheel base, treads, and a minimum ground clearance), a vehicle weight, a riding capacity, engine specifications (for example, the number and arrangement of cylinders, a valve mechanism, a displacement, a compression ratio, and a fuel injection system), travel performance (for example, a highest power output, a maximum torque, a fuel consumption rate, and a turning circle), specifications of a travel device (for example, a transmission gear ratio, a reduction ratio, specifications of a steering device, a tire size, brake specifications, suspension specifications, and stabilizer specifications), availability and specifications of optional equipment (for example, a navigation system, an audio system, a television set, and availability and specifications of a back camera), positions of mirrors (for example, a door mirror and a rearview mirror), and a display format of a speedometer (either kilometer per hour or mile per hour) of the vehicle 80. The storage unit 310 stores the vehicle information 31 for each of the plurality of vehicles 80 in, for example, a database format.

The storage unit 320 stores the reservation information 32. The reservation information 32 associates, with each other, a reservation ID which uniquely identifies a reservation, a vehicle ID of a reserved vehicle 80, information indicating a time slot in which the owner 51 has lent out the vehicle 80, information indicating a time slot in which there is a reservation for the vehicle 80, and a user ID uniquely identifying the user 41 having made a reservation for the vehicle 80. The reservation information 32 may associate the user ID of the user 41 with information related to a history of previous reservations made by the user 41. Information related to a history of previous reservations made by the user 41 may include, for example, the vehicle ID of a previously reserved vehicle 80, information indicating whether or not the vehicle had been returned by a scheduled return time, and evaluation information indicating an evaluation of the user 41 made by the owner 51 who is the lender of the vehicle 80 and made after the user 41 previously rented and used the vehicle 80 (for example, evaluation information indicating whether or not the vehicle 80 was used cleanly). The storage unit 320 stores the reservation information 32 for each of the plurality of vehicles 80 in, for example, a database format.

The storage unit 330 stores the user information 33. The user information 33 associates, with each other, the user ID of the user 41, personal information (for example, a name and an address) of the user 41, a reservation ID which identifies one or more reservations currently being made by the user 41, and a reservation ID which identifies one or more reservations previously made by the user 41. The storage unit 330 stores the user information 33 for each of a plurality of users 41 in, for example, a database format.

The storage unit 340 stores the driving characteristic information 34. The driving characteristic information 34 associates the user ID of the user 41 with information indicating a driving tendency of the user 41. The driving tendency of the user 41 signifies personal characteristics related to driving a vehicle and may be used as an index when determining whether or not the user 41 tends to, for example, drive safely in a law-abiding manner, drive in a fuel-efficient manner, drive while keeping a vehicle interior or exterior clean, or drive gently so that the vehicle is not subjected to an unnecessary load.

The driving characteristic information 34 may associate a user ID with history information on a driving state (for example, use/nonuse or a frequency of sudden braking, use/nonuse or a frequency of abrupt acceleration, use/nonuse or a frequency of abrupt steering, a frequency or mode of use of engine braking, use/nonuse or a frequency of unnecessary shift of gear, use/nonuse or a frequency of drifting, average fuel consumption, or instantaneous fuel consumption) detected by sensors 82 of the vehicle 80, for example, when the user 41 previously rented and used the vehicle 80, or may associate such history information with a travel time and a travel point.

The driving characteristic information 34 may associate, for example, the user ID with evaluation information indicating an evaluation of the user 41 made by the owner 51 who is the lender of the vehicle 80 and made after the user 41 previously rented and used the vehicle 80 (for example, an evaluation related to cleanliness of the vehicle interior or exterior).

The driving characteristic information 34 may associate, for example, the user ID with information indicating an estimated stain or damage of the vehicle interior based on a difference between a captured image of the vehicle interior before a start of use of the vehicle 80 by the user 41 and a captured image of the vehicle interior after the start of use of the vehicle 80 by the user 41 or information indicating an estimated stain or damage of the exterior based on a difference between a captured image of the exterior before the start of use of the vehicle 80 by the user 41 and a captured image of the exterior after the start of use of the vehicle 80 by the user 41.

The driving characteristic information 34 may associate, for example, the user ID with history information of the operating feel characteristic information 35 of each of the one or more vehicles 80 that the user 41 has previously used.

The storage unit 340 stores the driving characteristic information 34 for each of a plurality of users 41 in, for example, a database format.

The storage unit 350 stores the operating feel characteristic information 35. The operating feel characteristic information 35 associates the vehicle ID of the vehicle 80 with information indicating an operating feel of the vehicle 80. The operating feel of the vehicle 80 signifies sensory characteristics perceived by the user 41 during a driving operation of the vehicle 80, and includes dynamic response characteristics of the vehicle 80 with respect to an operation input from the user 41 (for example, a magnitude of force required to operate the operating members (for example, a steering wheel, an accelerator pedal, and a brake pedal) of the vehicle 80, turning characteristics (for example, understeer, neutral steer, or oversteer) of the vehicle 80 with respect to an operation of the steering wheel, suspension response characteristics (for example, either a ride comfort-prioritized setting or a sport driving-oriented setting), and sensitivity of an engine response with respect to an accelerator operation) and static characteristics of the vehicle 80 (for example, an arrangement pattern of a shift lever, a turning circle, mirror positions, and a display format of a speedometer). The storage unit 350 stores the operating feel characteristic information 35 for each of the plurality of vehicles 80 in, for example, a database format

The storage unit 360 stores the desire information 36. The desire information 36 associates the vehicle ID of the vehicle 80 with information indicating a driving tendency which the owner 51 who is the lender of the vehicle 80 desires with respect to the user 41 to be the renter of the vehicle 80. Examples of the driving tendency desired by the owner 51 include “driving while being easy on the vehicle”, “driving while keeping the vehicle interior or exterior clean”, “driving in a fuel-efficient manner”, and “driving safely”. The storage unit 360 stores the desire information 36 for each of the plurality of vehicles 80 in, for example, a database format.

The sensors 82 which detect a driving state of the vehicle 80 are, for example, sensors or switches for detecting a driving operation amount when the user 41 operates an operating member or an amount of change in a behavior of the vehicle 80 accompanying a driving operation by the user 41.

The sensors 82 may include, for example, an accelerator position sensor which detects an operation amount related to an acceleration operation by the user 41. The sensors 82 may include, for example, a brake position sensor which detects an operation amount related to a deceleration operation by the user 41. The sensors 82 may include, for example, a steering angle sensor which detects an operation amount related to a steering operation by the user 41. The sensors 82 may include, for example, a shift position sensor which detects an operation amount related to a shift operation by the user 41. The sensors 82 may include, for example, a turn signal lever which detects an operation amount related to a course change by the user 41.

The sensors 82 may include, for example, an angular velocity sensor (a gyro sensor) or an acceleration sensor which measures momentum acting on the vehicle 80 due to a change in the behavior of the vehicle 80 (one or more or all of rolling, pitching, yawing, bouncing, harshness, and jerk) which accompanies a driving operation by the user 41. Measuring the momentum which acts on the vehicle 80 enables an amount of change in the behavior of the vehicle 80 to be detected.

The communication device 81 mounted to the vehicle 80 associates detection information (for example, information related to a driving operation amount of an operating member or information related to an amount of change in the behavior of the vehicle 80) detected by the sensors 82 with the vehicle ID of the vehicle 80 and transmits the associated information to the vehicle information analysis system 60 via a wireless line. The communication device 81 may associate control information (for example, information such as an engine revolution speed, a vehicle speed, or fuel consumption) managed by an electronic control unit (ECU) of the vehicle 80 with the vehicle ID of the vehicle 80 together with the detection information detected by the sensors 82 and transmit the associated information to the vehicle information analysis system 60 via a wireless line.

The vehicle 80 may include a camera which images the vehicle interior or exterior. The communication device 81 may associate information on a captured image of the vehicle interior before the start of use of the vehicle 80 by the user 41 and information on a captured image of the vehicle interior after the start of use of the vehicle 80 by the user 41 with the vehicle ID of the vehicle 80 and the user ID, and transmit the associated information to the vehicle information analysis system 60 via a wireless line. The communication device 81 may associate information on a captured image of the exterior before the start of use of the vehicle 80 by the user 41 and information on a captured image of the exterior after the start of use of the vehicle 80 by the user 41 with the vehicle ID of the vehicle 80 and the user ID, and transmit the associated information to the vehicle information analysis system 60 via a wireless line.

The vehicle information analysis system 60 wirelessly communicates with each vehicle 80, receives detection information detected by the sensors 82 with or without control information of the ECU from the vehicle 80, and analyzes a driving state of each vehicle 80. For example, the vehicle information analysis system 60 is capable of analyzing how much the revolution speed of the engine changes relative to how much the accelerator pedal is depressed from a change in the revolution speed of the engine relative to an operation amount of the accelerator position sensor (an accelerator position) and determining a magnitude of force required to operate the accelerator pedal.

In a similar manner, by analyzing detection information and control information transmitted from the vehicle 80, for example, the vehicle information analysis system 60 can determine a magnitude of force required to operate the steering wheel or the brake pedal, turning characteristics of the vehicle 80 with respect to a steering wheel operation, response characteristics of a suspension, or sensitivity of an engine response with respect to an accelerator operation. In this manner, the vehicle information analysis system 60 is capable of determining dynamic response characteristics of the vehicle 80 with respect to an operation input from the user 41 among the sensory characteristics perceived by the user 41 during a driving operation of the vehicle 80.

The vehicle information analysis system 60 is capable of receiving the vehicle information 31 from the vehicle search system 10 through the communication network 90 and determining static characteristics (for example, an arrangement pattern of a shift lever, a turning circle, mirror positions, and a display format of a speedometer) among the sensory characteristics perceived by the user 41 during a driving operation of the vehicle 80.

In this manner, when the vehicle information analysis system 60 determines the sensory characteristics perceived by the user 41 during a driving operation of the vehicle 80, the vehicle information analysis system 60 transmits information related to the sensory characteristics to the vehicle search system 10 as the operating feel characteristic information 35 indicating an operating feel of the vehicle 80. The vehicle search system 10 stores the operating feel characteristic information 35 received from the vehicle information analysis system 60 in the storage unit 350.

The driving characteristic information analysis system 70 acquires the reservation information 32 and the user information 33 from the vehicle search system 10 through the communication network 90 and checks which user 41 is using which vehicle 80 in which time slot. The driving characteristic information analysis system 70 acquires detection information detected by the sensors 82 of the vehicle 80 used by a specific user 41 in a specific time slot and control information managed by the ECU of the vehicle 80 from the vehicle information analysis system 60 through the communication network 90, and analyzes the driving state of the vehicle 80 (for example, use/nonuse or a frequency of sudden braking, use/nonuse or a frequency of abrupt acceleration, use/nonuse or a frequency of abrupt steering, a frequency or mode of use of engine braking, use/nonuse or a frequency of unnecessary shift of gear, use/nonuse or a frequency of drifting, average fuel consumption, or instantaneous fuel consumption). The driving characteristic information analysis system 70 transmits history information of the driving state of the vehicle 80 analyzed in this manner to the vehicle search system 10 as the driving characteristic information 34 indicating the driving tendency of the specific user 41.

In addition, the driving characteristic information analysis system 70 extracts evaluation information indicating an evaluation of a specific user 41 made by the owner 51 who is the lender of the vehicle 80 and made after the user 41 previously rented and used the vehicle 80, from the reservation information 32, and transmits the evaluation information to the vehicle search system 10 as the driving characteristic information 34 indicating the driving tendency of the specific user 41.

Furthermore, the driving characteristic information analysis system 70 may acquire, from the vehicle information analysis system 60, information on captured images of the vehicle interior or exterior before and after use of the vehicle 80 by the user 41, and may estimate a stain or damage of the vehicle interior based on a difference between captured images of the vehicle interior before and after the use of the vehicle 80 by the user 41 or may estimate a stain or damage of the exterior based on a difference between captured images of the exterior before and after the use of the vehicle 80 by the user 41. The driving characteristic information analysis system 70 transmits information obtained by such estimations to the vehicle search system 10 as the driving characteristic information 34 indicating the driving tendency of the specific user 41.

The vehicle search system 10 stores the driving characteristic information 34 received from the driving characteristic information analysis system 70 in the storage unit 340. The vehicle search system 10 may store history information of the operating feel characteristic information 35 of each of the one or more vehicles 80 previously used by a specific user 41, in the storage unit 340 as the driving characteristic information 34 indicating the driving tendency of the specific user 41.

It should be noted that, when the specific user 41 does not have much of a record of use of the vehicle 80, driving characteristic information 34 with sufficient accuracy cannot always be obtained. In such a case, the driving characteristic information analysis system 70 may classify a large number of users 41 into a plurality of groups based on a certain criterion (for example, age or sex) and estimate the driving characteristic information 34 of the specific user 41 from the driving characteristic information 34 of other users belonging to the same group as the specific user 41. Clustering may be used as an example of such grouping.

The owner 51 connects to the input receiving unit 230 from the communication terminal 50 through the communication network 90 and inputs the desire information 36 indicating a driving tendency which the owner 51 who is the lender of the vehicle 80 desires with respect to the user 41 to be the renter of the vehicle 80. A method of inputting the desire information 36 may be, for example, a method of selecting check boxes corresponding to desired items prepared in advance or a method of setting priorities to the desired items prepared in advance. The method of inputting the desire information 36 may be, for example, a method of inputting desired items by characters or voice. The input receiving unit 230 may convert the desired items input by characters or voice into text information and estimate the desired items from keywords included in the text information. For example, when the keyword “safe driving” is included in the desired items, the input receiving unit 230 may estimate that the driving tendency desired by the owner 51 is “to drive safely”. The storage unit 360 stores the desire information 36 input to the input receiving unit 230.

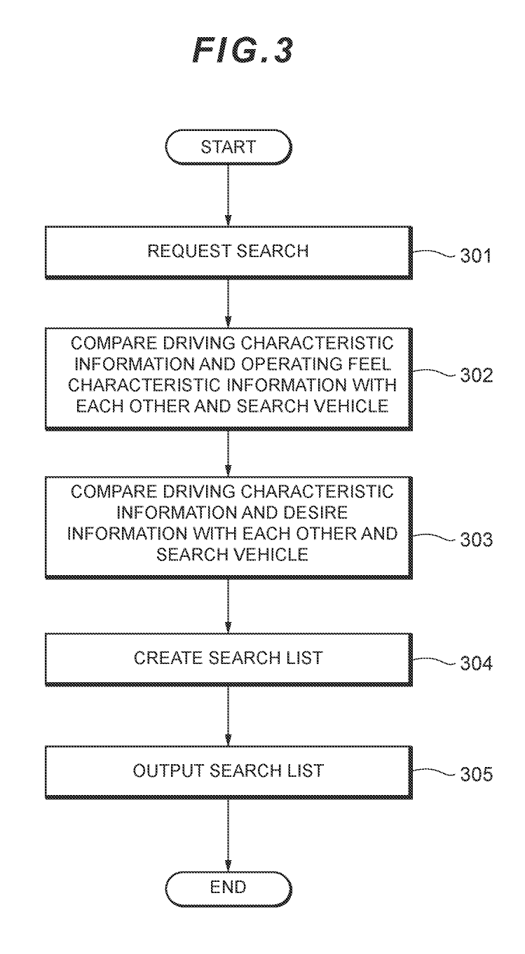

Next, details of the vehicle search method according to an embodiment of the present disclosure will be described mainly with reference to FIG. 2 and also with reference to FIG. 3 when appropriate.

The user 41 is capable of connecting to the reservation receiving unit 210 from the communication terminal 40 through the communication network 90 and performing various procedures (making, changing, and canceling a reservation) related to a reservation of the vehicle 80. Such procedures are performed by, for example, displaying a web page of a reservation screen on a display of the communication terminal 40 through transmission and reception of a request and a response conforming to HyperText Transfer Protocol between the communication terminal 40 and the vehicle search system 10.

In a reservation procedure, the reservation receiving unit 210 refers to the reservation information 32 of each vehicle 80 stored in the storage unit 320 and transmits information indicating a reservation status of each vehicle 80 to the communication terminal 40. The user 41 refers to the reservation status of each vehicle 80 and checks the presence or absence of one or more vehicles 80 which are available in a scheduled time slot of use. In addition, the user 41 inputs a vehicle type of the vehicle 80 which the user 41 desires to reserve, a reservation time/date (for example, a scheduled time/date of start of use and a scheduled time/date of end of use), and a user ID to the reservation receiving unit 210 from the communication terminal 40. The vehicle type refers to a classification according to a body type (for example, a sedan, a coupe, a van, or a truck). When the user 41 wishes to specify a vehicle type, the user 41 need only input a desired vehicle type to the reservation receiving unit 210 and need not specify the desired vehicle type.

In step 301, the reservation receiving unit 210 requests the searching unit 220 to search for the vehicle 80. For example, this search request includes a user ID, a reservation time/date and, when necessary, information on a desired vehicle type.

In step 302, the searching unit 220 acquires the driving characteristic information 34 associated with the user ID received in step 301 from the storage unit 340, compares the driving characteristic information 34 and the operating feel characteristic information 35 with each other, and searches one or more vehicles 80 having a degree of matching with the driving tendency of the user 41 that exceeds a threshold among the plurality of vehicles 80 which are available in a time slot on the reservation date/time specified by the user 41.

In step 303, the searching unit 220 further compares the driving characteristic information 34 and the desire information 36 with each other, and searches one or more vehicles 80 having a sum of a degree of matching with the driving tendency of the user 41 and a degree of matching with the desires of the owner 51 who is the lender of the vehicle 80 that exceeds a threshold among the plurality of vehicles 80 which are available in a time slot on the reservation date/time specified by the user 41.

For example, as the driving characteristic information 34 of the user 41, let us suppose that the evaluation of the user 41 made by an owner of a previously used vehicle is four on a scale of one to five, the frequency of sudden braking is 0.2 times per unit time, and a magnitude of force required to operate brakes of the previously used vehicle is four on a scale of one to five. As the desire information 36 of the owner 51, let us suppose that the evaluation of the user 41 made by another owner of a previously used vehicle is three or higher on a scale of one to five, the frequency of sudden braking is less than 0.25 times per unit time, and as the operating feel characteristic information 35 of the vehicle 80, a magnitude of force required to operate brakes is two on a scale of one to five. In this case, the driving tendency of the user 41 (“the magnitude of force required to operate brakes of the previously used vehicle is four on a scale of one to five”) and the operating feel of the vehicle 80 (“the magnitude of force required to operate brakes is two on a scale of one to five”) do not match each other. However, the driving tendency of the user 41 (“the evaluation of the user 41 made by an owner of a previously used vehicle is four on a scale of one to five”) matches a desired item of the owner 51 (“the evaluation of the user 41 made by another owner of a previously used vehicle is three or higher on a scale of one to five”). In addition, the driving tendency of the user 41 (“the frequency of sudden braking is 0.2 times per unit time”) matches a desired item of the owner 51 (“the frequency of sudden braking is less than 0.25 times per unit time”). In this example, since two out of three items match, a sum of the degree of matching with the driving tendency of the user 41 and the degree of matching with desires of the owner 51 who is the lender of the vehicle 80 is ⅔. It should be noted that while three items have been illustrated for the sake of convenience, a sum of degrees of matching may be obtained by comparing four items or more or a sum of degrees of matching may be obtained by multiplying each item by a weight coefficient.

In step 304, the searching unit 220 sorts the one or more searched vehicles 80 in a descending order of the degrees of matching with the driving tendency of the user 41 and with the desires of the owner 51, and creates a search list of the vehicles 80.

In step 305, the searching unit 220 outputs the search list created in step 304 to the reservation receiving unit 210.

Once the reservation receiving unit 210 receives the search list from the searching unit 220, the reservation receiving unit 210 transmits information (for example, Hyper Text) displaying a search result of the vehicles 80 to the communication terminal 40. The search result of the vehicles 80 is displayed on the display of the communication terminal 40, and the user 41 selects a vehicle 80 from the search result and performs a reservation procedure.

Although an example in which one or more vehicles 80 having a sum of a degree of matching with the driving tendency of the user 41 and a degree of matching with the desires of the owner 51 who is the lender of the vehicle 80 that exceeds a threshold is searched among the plurality of vehicles 80 which are available in a time slot on the reservation date/time specified by the user 41 has been described above, alternatively, one or more vehicles 80 having a sum of a degree of matching with the driving tendency of the user 41 and a degree of matching with the desires of the owner 51 who is the lender of the vehicle 80 that exceeds a threshold may be searched among a plurality of vehicles 80 which are available in a time slot that differs from the time slot on the reservation date/time specified by the user 41. When a vehicle 80 which is available in a time slot that differs from the time slot on the reservation date/time specified by the user 41 has a higher sum of a degree of matching with the driving tendency of the user 41 and a degree of matching with the desires of the owner 51 who is the lender of the vehicle 80 than any of the vehicles 80 which are available in the time slot on the reservation date/time specified by the user 41, the vehicle search system 10 may recommend the user 41 using the vehicle 80.

When there is no input of the desire information 36 from the owner 51, the vehicle search system 10 may omit step 303 and may search one or more vehicles 80 from the plurality of vehicles 80 in step 302.

In addition, the storage units 310 to 360 need not be logical volumes that differ from each other and a same logical volume may store a plurality of different types of information (for example, the driving characteristic information 34 and the operating feel characteristic information 35).

Furthermore, while a shared car has been described as an example of the vehicle 80 in the description given above, alternatively, the vehicle 80 may be a rental car.

In addition, the vehicle search system 10, the vehicle information analysis system 60, and the driving characteristic information analysis system 70 need not necessarily be separate and, for example, the vehicle search system 10 may be equipped with functions of one of or both the vehicle information analysis system 60 and the driving characteristic information analysis system 70.

With the vehicle search system 10 according to the present embodiment, a vehicle 80 having an operating feel which matches, as much as possible, a driving tendency of a user 41 can be searched. Accordingly, for example, even when the user 41 rents and uses a vehicle 80 of a vehicle type that differs from the vehicle type which the user 41 is accustomed to, the user 41 is not confused by the operating feel and is able to prevent accidents due to excessively pressing down the accelerator or abrupt steering.

In addition, with the vehicle search system 10 according to the present embodiment, an owner 51 of a vehicle 80 can allow the vehicle 80 to be rented and used by a user 41 having a driving tendency which matches, as much as possible, the owner's own desire. Furthermore, using evaluation information indicating an evaluation of the user 41 made by the owner 51 who is the lender of the vehicle 80 and made after the user 41 previously rented and used the vehicle 80 as the driving characteristic information 34 which indicates the driving tendency of the user 41 gives the user 41 an incentive to drive safely or drive gently so as to be evaluated highly by the owner 51, which is conducive to promoting the use of shared cars.

The embodiment described above is presented in order to facilitate understanding of the present disclosure and is not intended to limit the interpretation of the present disclosure. The present disclosure may be modified or improved without departing from the spirit and scope thereof and is intended to cover all equivalents thereof. For example, functions similar to the functions of the reservation reception module 21, the search module 22, and the input reception module 23 may be realized using a dedicated hardware resource (for example, an application specific integrated circuit (ASIC) or a field programmable gate array (FPGA)) or firmware. The reservation program 20 may be encoded into a prescribed signal format and transmitted to one computer system to another through a transmission medium (a wired communication network) or by transmission waves (radio waves). In addition, the functions of the vehicle search system 10 need not necessarily be realized by one computer system and may be realized by a plurality of computer systems connected to the communication network 90.

What is claimed is:

1. A vehicle search system, comprising:
a first storage unit which stores driving characteristic information indicating a driving tendency of a user;
a second storage unit which stores operating feel characteristic information indicating an operating feel of each of a plurality of vehicles; and
a searching unit which compares the driving characteristic information and the operating feel characteristic information with each other and searches, among the plurality of vehicles, one or more vehicles having a degree of matching with the driving tendency of the user that exceeds a threshold.

2. The vehicle search system according to claim 1, further comprising
a third storage unit which stores, in association with a vehicle, desire information indicating a driving tendency which a lender of the vehicle desires with respect to a user to be a renter of the vehicle, wherein
the searching unit further compares the driving characteristic information and the desire information with each other and searches, among the plurality of vehicles, one or more vehicles having a sum of a degree of matching with the driving tendency of the user and a degree of matching with a desire of the lender that exceeds a threshold.

3. The vehicle search system according to claim 1, wherein
the driving characteristic information includes evaluation information indicating an evaluation of the user made by a lender of a vehicle after the user previously rented and used the vehicle.

4. The vehicle search system according to any one of claim 1, wherein
the driving characteristic information includes history information of a driving state detected by sensors which detect a driving state of a vehicle when the user previously rented and used the vehicle.

5. A vehicle search method in which a computer system executes the steps of:
comparing driving characteristic information indicating a driving tendency of a user and operating feel characteristic information indicating an operating feel of each of a plurality of vehicles with each other; and
searching, among the plurality of vehicles, one or more vehicles having a degree of matching with the driving tendency of the user that exceeds a threshold.

6. A non-transitory computer readable medium storing a vehicle search program thereon, the program causing a computer system to:
compare driving characteristic information indicating a driving tendency of a user and operating feel characteristic information indicating an operating feel of each of a plurality of vehicles with each other; and
search, among the plurality of vehicles, one or more vehicles having a degree of matching with the driving tendency of the user that exceeds a threshold.
